(19) United States
(12) Patent Application Publication
(10) Pub. No.: US 2007/0120486 A1
(43) Pub. Date: May 31, 2007

(54) Plasma display panel

(76) Inventors: Sang-Hun Jang, Suwon-si (KR); Seung-Hyun Son, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/604,618

(22) Filed: Nov. 27, 2006

(30) Foreign Application Priority Data
Nov. 30, 2005 (KR) 10-2005-0115878

(51) Int. Cl. H01J 17/49

(52) U.S. Cl. 313/583; 313/582; 313/584; 313/586; 313/587

(57) ABSTRACT

Provided is a plasma display panel. The plasma display panel comprises: a front substrate; a rear substrate opposing the front substrate; a plurality of discharge electrodes disposed inside the substrates; a plurality of light emitting layers formed inside discharge cells; and an electron emitting source disposed inside the discharge cells so as to supply electrons, the area of electron emitting source differing in each of the discharge cells. The electron emitting source is installed in the discharge cells such that an electron emission characteristic is improved and brightness and luminous efficiency of the plasma display panel can be improved. The area of the electron emitting source or the number of electron emitting sources in each of the discharge cells differs such that a discharge characteristic in the discharge cells having lower brightness can be improved.

### CROSS-REFERENCE TO RELATED APPLICATION

This application claims the priority of Korean Patent Application No. 10-2005-0115878, filed on Nov. 30, 2005, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP in which sizes of electron emitting sources differ in each of discharge cells such that a discharge characteristic is improved.

2. Description of the Related Art

Generally, plasma display panels (PDP) are flat display devices in which a discharge gas is injected into a plurality of substrates and sealed between the substrates and, if a gas discharge occurs due to a voltage applied to a plurality of discharge electrodes, a phosphor layer is excited by ultraviolet rays generated in a discharge process and visible rays are emitted such that desired numbers, characters or graphics are realized.

A 3-electrode surface discharge type PDP that is often used includes a front substrate; a rear substrate opposing the front substrate; an X electrode and a Y electrode which are a sustain discharge electrode pair formed on an inner surface of the front substrate; a front dielectric layer burying the sustain discharge electrode pair; a protective layer coated on a surface of the front dielectric layer; an address electrode formed on an inner surface of the rear substrate and disposed to cross the sustain discharge electrode pair; a rear dielectric layer burying the address electrode; barrier ribs installed between the front and rear substrates; and red, green, and blue phosphor layers coated on insides of the barrier ribs and a surface of the rear dielectric layer. A discharge gas is injected into an inner space in which the front and rear substrates are combined with each other, thereby forming a discharge region.

In a conventional PDP having the above structure, electrons are continuously supplied and accelerated through a discharge; the accelerated electrons collide with neutral particles and excitation particles are generated by the collision, ultraviolet rays are emitted by the excitation particles, a phosphor layer is excited by the ultraviolet rays whereby visible rays are generated.

However, in this procedure, ions that do not increase luminous efficiency are generated, much energy is consumed in accelerating the ions such that discharge efficiency is very low due to an unnecessary energy loss.

In addition, due to a discharge characteristic, if discharge cells are made smaller, a problem with reliability occurs, in that discharge efficiency is further lowered and an unstable discharge occurs. Thus, for the present, PDPs have been mainly used in a video graphics array (VGA) (640×480) and a super VGA (SVGA) (800×600). However, high definition is needed for development of a PDP for high definition television (HDTV) (1920×1035).

### SUMMARY OF THE INVENTION

The present embodiments provide a plasma display panel (PDP) in which the area or the number of discharge electrodes or electron emitting sources such as porous silicon oxidized on a dielectric layer differs such that brightness is controlled by discharge cells.

According to an aspect of the present embodiments, there is provided a plasma display panel comprising: a front substrate; a rear substrate opposing the front substrate; a plurality of discharge electrodes disposed inside the substrates; a plurality of light emitting layers formed inside discharge cells; and an electron emitting source disposed inside the discharge cells so as to supply electrons, an area of electron emitting source differing in each of the discharge cells.

The electron emitting source may include: a first electrode which becomes a source for emitting electrons; and an electron accelerating layer formed on the first electrode.

The electron accelerating layer may be one layer selected from the group consisting of an oxidized porous poly silicon (OPPS) layer and an oxidized porous amorphous silicon (OPAS) layer.

A second electrode may be further formed on the electron accelerating layer so that an electric field can be formed between the first electrode and the second electrode.

The light emitting layer may be formed on an inner surface of other substrate corresponding to a substrate on which the electron emitting source is installed.

An area of the electron emitting source disposed in discharge cells having lower brightness may be larger than an area of an electron emitting source disposed in discharge cells having higher brightness.

According to another aspect of the present embodiments, there is provide a plasma display panel comprising: a front substrate; a rear substrate opposing the front substrate; a plurality of discharge electrodes disposed inside the substrates; a plurality of light emitting layers applied inside discharge cells; and an electron emitting source disposed inside the discharge cells so as to supply electrons, the number of electron emitting source differing in each of the discharge cells.

The number of electron emitting sources disposed in discharge cells having a lower brightness may be larger than the number of electron emitting sources disposed in discharge cells having higher brightness.

A plurality of electron emitting sources disposed in discharge cells having lower brightness, respectively, may be disposed along both opposed edges of the discharge cells.

### BRIEF DESCRIPTION OF THE DRAWINGS

The above and other aspects and advantages of the present embodiments will become more apparent by describing in detail exemplary embodiments thereof with reference to the attached drawings in which:

FIG. 1 is a combined cross-sectional view of a plasma display panel (PDP) according embodiment;

FIG. 2 is a combined cross-sectional view of a PDP according to another embodiment;

FIG. 3 is a combined cross-sectional view of a PDP according to another embodiment;

FIG. 4 is a combined cross-sectional view of a PDP according to another embodiment;

FIG. 5 is a combined cross-sectional view of a PDP according to another embodiment; and

FIG. 6 is a combined cross-sectional view of a PDP according to another embodiment.

### DETAILED DESCRIPTION OF THE INVENTION

The present embodiments will now be described more fully with reference to the accompanying drawings, in which exemplary embodiments are shown.

FIG. 1 illustrates a plasma display panel (PDP) 100 according to an embodiment. Referring to FIG. 1, the PDP 100 includes a front substrate 101 and a rear substrate 102 parallel to the front substrate 101. The front substrate 101 and the rear substrate 102 form a discharge space sealed by a frit glass coated along edges of opposed inner surfaces.

The front substrate 101 may be a transparent substrate such as, for example, a soda lime glass, a semi-transmitted type substrate, a reflective type substrate or a colored substrate. A sustain discharge electrode pair 103 is formed on an inner surface of the front substrate 101. The sustain discharge electrode pair 103 includes an X electrode 104 and a Y electrode 105. A pair of the X electrode 104 and the Y electrode 105 is disposed by discharge cells.

The X electrode 104 includes a first discharge electrode line 104a disposed along one direction of the PDP 100 and a first bus electrode line 104b disposed along one edge of the surface of the first discharge electrode line 104a. The first discharge electrode line 104a and the first bus electrode line 104b have striped shapes.

The Y electrode 105 includes a second discharge electrode line 105a disposed along one direction of the PDP 100 and a second bus electrode line 105b disposed along one edge of the surface of the second discharge electrode line 105a. The second discharge electrode line 105a and the second bus electrode line 105b have striped shapes. The Y electrode 105 opposes the X electrode 104 by discharge cells. It is advantageous that the Y electrode 105 and the X electrode 104 are symmetrical with each other so that a discharge is uniformly performed.

According to the current embodiment, the first discharge electrode line 104a and the second discharge electrode line 105a are formed of a transparent conductive film, and the first bus electrode line 104b and the second bus electrode line 105b may be formed of a silver paste having high conductivity or metal such as chrome-copper-chrome, in order to compensate for a line resistance of the first discharge electrode line 104a and the second discharge electrode line 105a.

The X electrode 104 and the Y electrode 105 include the first and second discharge electrode lines 104a and 105a formed of an ITO film, respectively, and the first and second bus electrode lines 104a and 105b formed of metal and disposed along one edge of an upper surface of each of the X electrode 104 and the Y electrode 105, respectively. However, the present embodiments are not limited to this.

The X electrode 104 and the Y electrode 105 are buried by the front dielectric layer 106. The front dielectric layer 106 is formed of transparent dielectric such as a high dielectric material, for example, PbO—B₂O₃—SiO₂.

A protective layer 107 made of, for example, magnesium oxide (MgO) is formed on the surface of the front dielectric layer 106, so as to increase the amount of secondary electron emitted. The protective layer 107 is deposited on the surface of the front dielectric layer 106.

The rear substrate 102 may be a transparent substrate, a semi-transmitted type substrate, a reflective type substrate or a colored substrate. An address electrode 108 is disposed on an inner surface of the rear substrate 102 to cross the X electrode 104 and the Y electrode 105. The address electrode 108 has a striped shape and goes across adjacent discharge cells along other direction of the PDP 100. The address electrode 108 is formed of metal having high conductivity, for example, a silver paste. The address electrode 108 is buried by the rear dielectric layer 109. The rear dielectric layer 109 is formed of a high dielectric material, as is the front dielectric layer 106.

Barrier ribs 110 are disposed between the front substrate 101 and the rear substrate 102. The barrier ribs 110 are formed to define the discharge cells and to prevent crosstalk between the adjacent discharge cells.

The barrier ribs 110 have one of striped, meander, and matrix shapes that can partition a discharge space. A cross-section of the discharge space partitioned by the barrier ribs 110 may be, for example, polygonal, circular, or elliptical shaped.

A light emitting layer 111 is coated on an inner surface of the protective layer 107 by discharge cells. A light emission mechanism in which visible rays can be emitted by a discharge is present in the light emitting layer 111. The light emitting layer 111 includes a red light emitting layer 111R, a green light emitting layer 111G, and a blue light emitting layer 111B so that the PDP 100 can realize color images. The red light emitting layer 111R, the green light emitting layer 111G, and the blue light emitting layer 111B are disposed inside each of discharge cells and respectively form a sub-pixel.

The light emitting layer 111 may be formed of a material in which atoms which were released by an energy generated in a ultraviolet region are stabilized and visible rays can be generated. A photo luminescence (PL) phosphor layer or a quantum dot may be used for the light emitting layer 111.

Since quantum dots have no interference between atoms, if an energy is generated from the outside, atoms released at an atom energy level are stabilized and emit light. Thus, since excitation can be performed with a low voltage, luminous efficiency can be improved and a printing process is possible which is advantageous in making a PDP larger.

Here, the area or number of discharge cells differs so that an electron emitting source for generating a larger amount of electrons in large-area or a number of discharge cells is disposed, which will be described in greater details as follows.

The electron emitting source 115 is disposed in a discharge space defined by the barrier ribs 110. The electron emitting source 115 includes a red electron emitting source 112, a green electron emitting source 113, and a blue electron emitting source 114.

The red electron emitting source 112 includes a first electrode 112a formed on a upper surface of the rear dielectric layer 109 and a first electron accelerating layer 112b having the same width as the first electrode 112a and formed on the surface of the first electrode 112a.

The green electron emitting source 113 includes a second electrode 113a formed on the upper surface of the rear dielectric layer 109 in other discharge cells adjacent to the discharge cells in which the red electron emitting source 112 is disposed and a second electron accelerating layer 113b having the same width as the second electrode 113a and formed on the surface of the second electrode 113a.

The blue electron emitting source 114 includes a third electrode 114a formed on the upper surface of the rear dielectric layer 109 in other discharge cells adjacent to the discharge cells in which the green electron emitting source 113 is disposed and a third electron accelerating layer 114b having the same width as the third electrode 114a and formed on the surface of the second electrode 114a.

If the width of the red electron emitting source 112 is W₁, the width of the green electron emitting source 113 is W₂ and the width of the blue electron emitting source 114 is W₃, the width W₃ of the blue electron emitting source 114 is larger than the width W₁ of the red electron emitting source 112 or the width W₂ of the green electron emitting source 113.

As a result, even when the same power is applied to the red electron emitting source 112, the green electron emitting source 113, and the blue electron emitting source 114, respectively, the amount of electrons supplied to the blue discharge cells in which the blue electron emitting source 114 is disposed is larger than the amount of electrons supplied to the red discharge cells in which the red electron emitting source 112 is disposed or the amount of electrons supplied to the green discharge cells in which the green electron emitting source 113 is disposed.

The first, second, and third electrodes 112a, 113a, and 114a may be formed of a transparent conductive layer, such as an indium tin oxide (ITO) layer, or a metallic layer having high conductivity, such as Al or Ag. The first, second, and third electrodes 112a, 113a, and 114a are coupled to ground and biased to 0 V.

The first, second, and third electron accelerating layers 112b, 113b, and 114b may be formed of a material in which atoms are accelerated and electron beams can be generated, for example, an oxidized porous silicon (OPS) layer. OPS includes oxidized porous poly silicon (OPPS) or oxidized porous amorphous silicon (OPAS).

As an alternative, an electron emitting source including boron nitride bamboo shoot (BNBS) may be used. BNBS has a transparent property in a wavelength region of from about 380 to about 780 nanometers, which is a visible ray region, and BNBS has negative electron affinity and thus, the electron emission characteristic of BNBS is excellent.

Even when BNBS is used, the first, second, and third electrodes 112a, 113a, and 114a are formed on the surface of the rear dielectric layer 109 in each of the red, green, and blue discharge cells, and a BNBS layer is formed on the surface of the first, second, and third electrodes 112a, 113a, and 114a to have the same width as the widths thereof.

A discharge gas is injected in an internal space sealed by the front substrate 101 and the rear substrate 102 combined with each other. The discharge gas can be for example, xenon (Xe) gas, neon (Ne) gas, helium (He) gas, argon (Ar) gas or any mixture thereof.

In this case, the gas in which the electron beams emitted from the electron emitting source 115 are used may be a gas which is excited by an external energy generated by the electron beams and can generate ultraviolet (UV) rays. That is, various gases such as N₂, heavy hydrogen, carbon dioxide, hydrogen gas, carbon monoxide, and krypton (Kr) or an atmospheric pressure air may also be used. In addition, a discharge gas that is usually used in a PDP may be used.

The operation of the PDP 100 having the above structure according to the present embodiments will now be described.

First, if an address voltage is applied between the Y electrode 105 and the address electrode 108, an address discharge occurs. Discharge cells in which a sustain discharge will occur as a result of the address discharge are selected.

In this case, an electric field is formed between the Y electrode 105 and the address electrode 108. Due to the electric field, electrons flow into the first, second, and third electron accelerating layers 112b, 113b, and 114b from the first, second, and third electrodes 112a, 113a, and 114a, and the electrons pass through the first, second, and third electron accelerating layers 112b, 113b, and 114b and are accelerated and then are emitted into the discharge cells.

If the electrons flow into the discharge cells, an address discharge can occur smoothly. Thus, an address driving voltage can be reduced and a sufficient address discharge can be performed.

Next, if a sustain discharge voltage is applied between the X electrode 104 and the Y electrode 105 in the selected discharge cells, due to movement of wall charges accumulated on the X electrode 104 and the Y electrode 105, a sustain discharge in a surface discharge form occurs.

If the sustain discharge occurs, the energy level of the excited discharge gas during the sustain discharge is reduced and UV rays are emitted. The UV rays excite the red, green, and blue light emitting layers 111R, 111G, and 111B applied in the discharge cells.

After that, the energy level of the excited red, green, and blue light emitting layers 111R, 111G, and 111B is reduced, visible rays are emitted through the front substrate 101, and the emitted visible rays constitute an image.

In this way, in the PDP 100 according to the present embodiments, the electron emitting source 115 is disposed above the address electrode 102 such that a characteristic of emitting electrons into the discharge cells during the address discharge is improved such that an address voltage to be applied during the address discharge can be reduced. Thus, a leakage current between the address electrodes 102 during the address discharge can be reduced, and crosstalk between the discharge cells is prevented such that the number of discharge errors can be reduced.

In addition, during the sustain discharge, an electric field is also formed between the X electrode 104 and the Y electrode 105. Due to the electric field, electrons pass through the first, second, and third electron accelerating layers 112b, 113b, and 114b and are accelerated and then are emitted into the discharge cells. Thus, since sufficient electrons are emitted into the discharge cells from the electron emitting source 115 during the sustain discharge as well as during the address discharge, a discharge sustain voltage to be applied during the sustain discharge is reduced and the sustain discharge can be performed such that discharge efficiency can be improved.

In particular, in order to improve discharge brightness in the blue discharge cells having lower discharge efficiency, the area of the blue electron emitting source 114 disposed in the blue discharge cells is larger than the area of the red electron emitting source 112 and the area of the green electron emitting source 113 disposed in the green discharge cells. As such, a larger amount of electrons are generated in the blue discharge cells, and a large amount of excitation species are formed in the discharge cells such that brightness is compensated for.

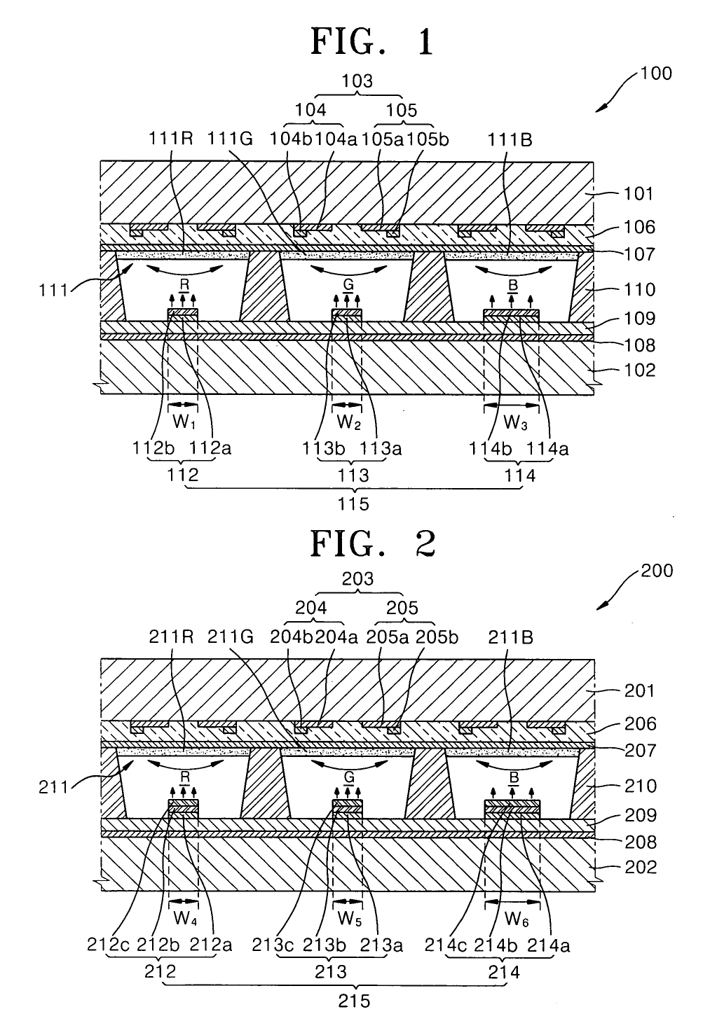

FIG. 2 illustrates a plasma display panel (PDP) 200 according to another embodiment. Referring to FIG. 2, the PDP 200 includes a front substrate 201 and a rear substrate 202 that opposes the front substrate 201.

A pair of sustain discharge electrodes 203 having an X electrode 204 in which a sustaing discharge occurs and a Y electrode 205 are disposed on an inner surface of the front substrate 201. The X electrode 204 includes a first discharge electrode line 204a and a first bus electrode line 204b disposed along one edge of the first discharge electrode line 204a. The Y electrode 205 includes a second discharge electrode line 205a and a second bus electrode line 205b disposed along one edge of the second discharge electrode line 205a. The sustain discharge electrode 203 is buried by a front dielectric layer 206. A protective layer 207 is formed on an inner surface of the front dielectric layer 206.

An address electrode 208 is disposed on an inner surface of the rear substrate 202 to across the pair of sustain discharge electrodes 203. The address electrode 208 is buried by a rear dielectric layer 209.

Barrier ribs 210 for partitioning a discharge space and preventing crosstalk are installed between the front substrate 201 and the rear substrate 202. In addition, a light emitting layer 211 is formed on an inner surface of the protective layer 207. The light emitting layer 211 includes a red light emitting layer 211R, a green light emitting layer 211G, and a blue light emitting layer 211B in each of discharge cells so that color images can be realized.

In this case, an electron emitting source 215 is disposed in the discharge space defined by the barrier ribs 210. The electron emitting source 215 includes a red electron emitting source 212, a green electron emitting source 213, and a blue electron emitting source 214.

The red electron emitting source 212 includes a first electrode 212a formed on an upper surface of the rear dielectric layer 208, a first electron accelerating layer 212b having the same width as the first electrode 212a and formed on the surface of the first electrode 212a and a second electrode 212c formed on an upper surface of the first electron accelerating layer 212b.

The green electron emitting source 213 includes a third electrode 213a formed on the upper surface of the rear dielectric layer 209 in other discharge cells adjacent to the discharge cells in which the red electron emitting source 212 is disposed, a second electron accelerating layer 213b having the same width as the third electrode 213a and formed on the surface of the third electrode 213a and a fourth electrode 213c formed on an upper surface of the second electron accelerating layer 213b.

The blue electron emitting source 214 includes a fifth electrode 214a formed on the upper surface of the rear dielectric layer 209 in other discharge cells adjacent to the discharge cells in which the green electron emitting source 213 is disposed, a third electron accelerating layer 214b having the same width as the fifth electrode 214a and formed on the surface of the fifth electrode 214a and a sixth electrode 214c formed on an upper surface of the third electron accelerating layer 214b.

As such, the first, third, and fifth electrodes 212a, 213a, and 214a are cathode electrodes, and the second, fourth, and sixth electrodes 212c, 213c, and 214c are grid electrodes. The first, third, and fifth electrodes 212a, 213a, and 214a are ground biased, and voltages are applied to the second, fourth, and sixth electrodes 212c, 213c, and 214c, respectively, such that an accelerating energy of emitted electrons can be controlled according to sizes of the voltages.

In addition, if a predetermined voltage is applied to the first, third, and fifth electrodes 212a, 213a, and 214a, respectively, and the second, fourth, and sixth electrodes 212c, 213c, and 214c, respectively, the first, second, and third electron accelerating layers 212b, 213b, and 214b accelerate electrons flowing from the first, third, and fifth electrodes 212a, 213a, and 214a so that electron beams can be emitted into the discharge cells through the second, fourth, and sixth electrodes 212c, 213c, and 214c.

In this case, the electron beams may be larger than an energy needed in exciting a gas and smaller than an energy needed in ionizing the gas. Thus, a predetermined voltage having an optimized electron energy in which electron beams can excite a discharge gas may be applied to the first, third, and fifth electrodes 212a, 213a, and 214a, respectively and the second, fourth, and sixth electrodes 212c, 213c, and 214c, respectively.

As another embodiment of the first, second, and third electron accelerating layers 212b, 213b, and 214b, a metal-insulator-metal (MIM) structure is also possible. That is, if a predetermined voltage is applied between a cathode electrode and a grid electrode, a thin insulating layer starting from the cathode electrode is tunneled and then passes through the grid electrode and is emitted in a space. In this case, materials and thicknesses of the insulating layer and the grid electrodes may be controlled so that electrons can be emitted in the space with as large an accelerating energy as possible without colliding with the insulating layer and the grid electrode.

In this case, the area of the blue electron emitting source 214 is larger than the area of the red electron emitting source 212 and the area of the green electron emitting source 213. That is, if the width of the blue electron emitting source 214 is W₆, the width of the red electron emitting source 212 is W₄ and the width of the green electron emitting source 213 is W₅, the width W₆ of the blue electron emitting source 214 is larger than the width W₄ of the red electron emitting source 212 or the width W₅ of the green electron emitting source 213.

This is because brightness in the blue discharge cells is lowered compared to other discharge cells due to a material characteristic of the blue light emitting layer 211B and a larger amount of electrons is emitted so that lowering of brightness can be compensated for.

The first through sixth electrodes 212a, 212c, 213a, 213c, 214a, and 214c are transparent conductive layers such as ITO layers and may be formed of metal having high conductivity, such as Al or Ag. In addition, the first, second, and third electron accelerating layers 212b, 213b, and 214b may be formed of a material in which atoms are accelerated and electron beams can be generated, for example, an oxidized porous silicon (OPS) layer. OPS includes oxidized porous poly silicon (OPPS) or oxidized porous amorphous silicon (OPAS). Furthermore, an electron emitting source including boron nitride bamboo shoot (BNBS) may be used. A discharge gas is injected in a sealed discharge space, and the discharge gas can be, for example, xenon (Xe) gas, neon (Ne) gas, helium (He) gas, argon (Ar) gas or any mixture thereof. In this case, the gas in which the electron beams emitted from the electron emitting source 215 are used may be a gas which is excited by an external energy generated by the electron beams and can generated ultraviolet (UV) rays.

In the PDP 200 having the above structure according to the present embodiments, if a predetermined address voltage is applied between the Y electrode 205 and the address electrode 208, an address discharge occurs. Discharge cells in which a sustain discharge will occur as a result of the address discharge are selected.

In this case, an electric field is formed between the Y electrode 205 and the address electrode 208. Due to the electric field, electrons flow into the first, second, and third electron accelerating layers 212b, 213b, and 214b from the first, second, and third electrodes 212a, 213a, and 214a, and the electrons pass through the first, second, and third electron accelerating layers 212b, 213b, and 214b and are accelerated and then are emitted into the red, green, and blue discharge cells.

If the electrons flow into the discharge cells, an address discharge can occur smoothly. Thus, an address driving voltage can be reduced and a sufficient address discharge can be performed.

Next, if a sustain discharge voltage is applied between the X electrode 204 and the Y electrode 205 in the selected discharge cells, due to movement of wall charges accumulated on the X electrode 204 and the Y electrode 205, a sustain discharge in a surface discharge form occurs.

If the sustain discharge occurs, an energy level of the excited discharge gas during the sustain discharge is reduced and UV rays are emitted. The UV rays excite the red, green, and blue light emitting layers 211R, 211G, and 211B applied in the discharge cells. After that, the energy level of the excited red, green, and blue light emitting layers 211R, 211G, and 211B is reduced, visible rays are emitted through the front substrate 201, and the emitted visible rays constitute an image that can be recognized by a user.

In this case, the width of the blue electron emitting source 214 having lower brightness than brightness of the red electron emitting source 212 or the green electron emitting source 213 is larger than the other electron emitting sources 212 and 213 so that a larger amount of electrons are generated in the blue discharge cells and brightness can be improved.

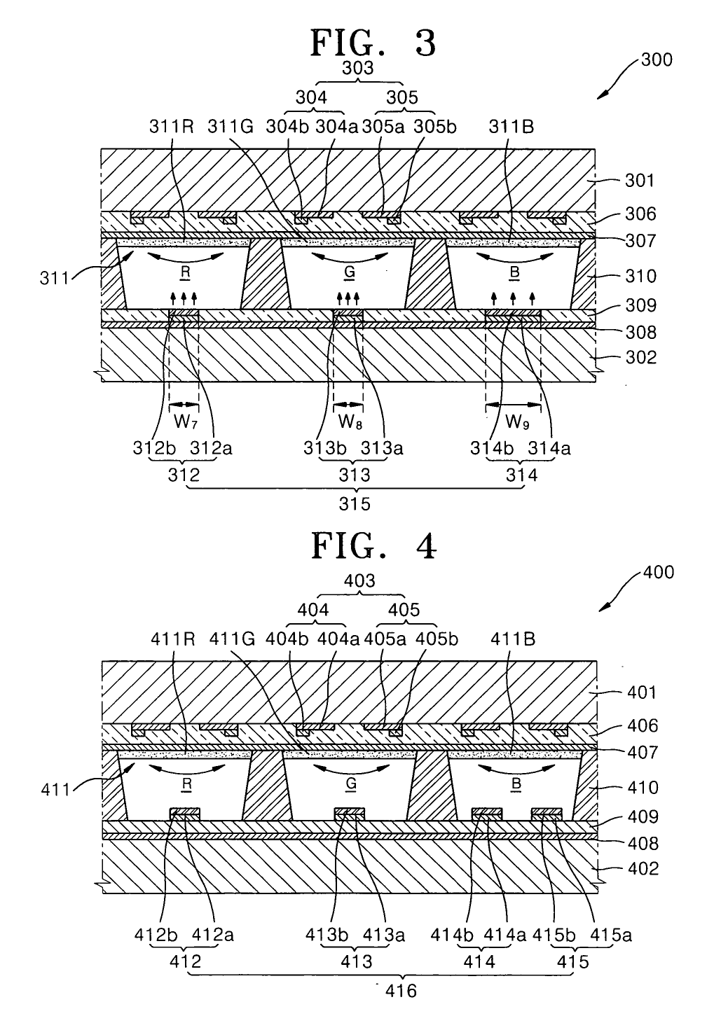

FIG. 3 illustrates a plasma display panel (PDP) 300 according to another embodiment. Referring to FIG. 3, the PDP 300 includes a front substrate 301 and a rear substrate 302 that opposes the front substrate 301. A frit glass is applied to an inner edge in which the front substrate 301 and the rear substrate 302 oppose each other so that a sealed inner space is formed.

A pair of sustain discharge electrodes 303 are disposed on an inner surface of the front substrate 301. The pair of sustain discharge electrodes 303 include an X electrode 304 and a Y electrode 305 that crosses the X electrode 304. The X electrode 304 includes a first discharge electrode line 304a and a first bus electrode line 304b disposed along one edge of the first discharge electrode line 304a. The Y electrode 305 includes a second discharge electrode line 305a and a second bus electrode line 305b disposed along one edge of the second discharge electrode line 305a. The pair of sustain discharge electrodes 303 are buried by a front dielectric layer 306. A protective layer 307 is formed on an inner surface of the front dielectric layer 306.

An address electrode 308 is disposed on an inner surface of the rear substrate 302 to cross the pair of sustain discharge electrodes 306. The address electrode 308 is buried by a rear dielectric layer 309.

Barrier ribs 310 for partitioning a discharge space are disposed between the front substrate 301 and the rear substrate 302. A light emitting layer 311 is applied to discharge cells defined by the barrier ribs 310. According to the current embodiment, a red lighting emitting layer 311R, a green light emitting layer 311G, and a blue light emitting layer 311B, respectively, are applied to adjacent discharge cells along an inner surface of the protective layer 307.

In this case, an electron emitting source 315 is disposed on an upper surface of the address electrode 308. The electron emitting source 315 includes a red electron emitting source 312, a green electron emitting source 313, and a blue electron emitting source 314.

The red electron emitting source 312 includes a first electron accelerating layer 312a that contacts the surface of the address electrode 308 and a first electrode 312b having the same width as the first electron accelerating layer 312a. The address electrode 308 is an electrode for supplying electrons, as mentioned in FIGS. 1 and 2.

The green electron emitting source 313 includes a second electron accelerating layer 313a formed on the surface of the address electrode 308 in other discharge cells adjacent to the discharge cells in which the red electron emitting source 312 is disposed and a second electrode 313b having the same width as the second electron accelerating layer 313a and formed on the surface of the second electron accelerating layer 313a.

The blue electron emitting source 314 includes a third electron accelerating layer 314a formed on the surface of the address electrode 308 in other discharge cells adjacent to the discharge cells in which the green electron emitting source 313 is disposed and a third electrode 314b having the same width as the third electron accelerating layer 314a and formed on the surface of the third electron accelerating layer 314a.

In this case, an oxidized porous silicon (OPS) layer is used for the first, second, and third electron accelerating layers 312a, 313a, and 314a. The OPS layer includes an oxidized porous poly silicon (OPPS) or an oxidized porous amorphous silicon (OPAS) layer.

Furthermore, the first, second, and third electron accelerating layers 312a, 313a, and 314a contact the surface of the address electrode 308 but the present embodiments are not limited to this. That is, an electron accelerating layer may contact the side of the address electrode and may be a structure in which the electron accelerating layer contacts the address electrode 308 and electrons can flow into the electron accelerating layer. Thus, there is no limitation in the arrangement shape of the electron accelerating layer.

The first, second, and third electrodes 312b, 313b, and 314b may be formed in a mesh structure so that electrons accelerated by the first, second, and third electron accelerating layers 312a, 313a, and 314a can be easily emitted. In addition, the first, second, and third electrodes 312b, 313b, and 314b are installed inside the rear dielectric layer 309 together with the first, second, and third electron accelerating layers 312a, 313a, and 314a. The first, second, and third electrodes 312b, 313b, and 314b are configured in a shape in which other portions of the address electrode 308 are buried, other than a portion in which the first,'second, and third electrodes 312b, 313b, and 314b are installed. However, the first, second, and third electrodes 312b, 313b, and 314b are positioned on the rear dielectric layer 309 and may also be exposed in the discharge cells.

Here, the area of the blue electron emitting source 314 is larger than the area of the red electron emitting source 312 and the area of the green electron emitting source 313.

That is, if the width of the blue electron emitting source 314 is W₉, the width of the red electron emitting source 312 is W₇ and the width of the green electron emitting source 313 is W₈, the width W₉ of the blue electron emitting source 314 is larger than the width W₇ of the red electron emitting source 312 or the width W₈ of the green electron emitting source 313.

In this way, by making the area of the blue electron emitting source 314 larger than the areas of the red and green electron emitting sources 312 and 313, lowering of brightness is compensated for in the blue discharge cells due to a material characteristic of the blue light emitting layer 311B.

The operation of the PDP 300 having the above structure according to the present embodiments will now be described.

If a predetermined address voltage is applied between the Y electrode 305 and the address electrode 308, an address discharge occurs. Discharge cells in which a sustain discharge will occur as a result of the address discharge are selected.

In this case, electrons flow into the first, second, and third electron accelerating layers 312a, 313a, and 314a from the address electrode 308 and accelerated. The accelerated electrons are emitted into the discharge cells via the first, second, and third electrodes 312b, 313b, and 314b. Even in this case, an electric field is formed between the Y electrode 305 and the address electrode 308. Due to the electric field, electrons more easily flow into the first, second, and third electron accelerating layers 312a, 313a, and 314a from the address electrode 308 and accelerated and emitted into the discharge cells.

If the electrons flow into the discharge cells, an address discharge can occur smoothly. Thus, an address driving voltage can be reduced and a sufficient address discharge can be performed.

Next, if a sustain discharge voltage is applied between the X electrode 304 and the Y electrode 305 in the selected discharge cells, due to movement of wall charges accumulated on the X electrode 304 and the Y electrode 305, a sustain discharge in a surface discharge form occurs.

Even in the sustain discharge, an electric field is formed between the X electrode 304 and the Y electrode 305. If the electric field is generated, electrons flow into the first, second, and third electron accelerating layers 312a, 313a, and 314a from the address electrode 308. The electrons pass through the first, second, and third electron accelerating layers 312a, 313a, and 314a and are accelerated and then are emitted into the discharge cells via the first, second, and third electrodes 312b, 313b, and 314b.

As such, a sustain discharge can be sufficiently performed even when a sustain discharge voltage is reduced such that discharge efficiency is improved. This case corresponds to the case where a voltage is not directly applied to the address electrode 308 during a sustain discharge. However, if a lower voltage than a voltage during an address discharge is applied to the address electrode 308 during the sustain discharge, electrons more briskly flow into the discharge cells such that discharge efficiency is further improved.

If the sustain discharge occurs, the energy level of the excited discharge gas during the sustain discharge is reduced and UV rays are emitted. The UV rays excite the red, green, and blue light emitting layers 311R, 311G, and 311B applied in the discharge cells. After that, the energy level of the excited red, green, and blue light emitting layers 311R, 311G, and 311B is reduced, visible rays are emitted and constitute an image

In particular, in order to improve discharge brightness in the blue discharge cells having lower discharge efficiency, the area of the blue electron emitting source 314 disposed in the blue discharge cells is larger than the area of the red electron emitting source 312 disposed in the red discharge cells and the area of the green electron emitting source 313 disposed in the green discharge cells. As such, a large amount of electrons is generated in the blue discharge cells, and a large amount of excitation species is formed in the discharge cells such that brightness is compensated for.

FIG. 4 illustrates a plasma display panel (PDP) 400 according to another embodiment. Referring to FIG. 4, the PDP 400 includes a front substrate 401 and a rear substrate 402 parallel to the front substrate 401.

A pair of sustain discharge electrodes 403 are disposed on an inner surface of the front substrate 401. The pair of sustain discharge electrodes 403 include an X electrode 404 and a Y electrode 405. The X electrode 404 includes a first discharge electrode line 404a and a first bus electrode line 404b disposed along one edge of the first discharge electrode line 404a. The Y electrode 405 includes a second discharge electrode line 405a and a second bus electrode line 405b disposed along one edge of the second discharge electrode line 405a.

The pair of sustain discharge electrodes 403 are buried by a front dielectric layer 406. A protective layer 407 is formed on the surface of the front dielectric layer 406. An address electrode 408 is disposed on an inner surface of the rear substrate 402 to cross the pair of sustain discharge electrodes 403. Barrier ribs 410 are disposed between the front substrate 401 and the rear substrate 402.

In addition, a light emitting layer 411 is coated on an inner surface of the protective layer 407 in each of discharge cells. The light emitting layer 411 includes a red emitting layer 411R, a green light emitting layer 411G, and a blue light emitting layer 411B. The red emitting layer 411R, the green light emitting layer 411G, and the blue light emitting layer 411B, respectively, are disposed in each of the discharge cells and form a subpixel so that the PDP 400 can realize a color image.

In this case, an electron emitting source 416 is disposed in a discharge space defined by the barrier ribs 410. The electron emitting source 416 includes a red electron emitting source 412, a green electron emitting source 413, and blue electron emitting sources 414 and 415.

The red electron emitting source 412 includes a first electrode 412a formed on an upper surface of a rear dielectric layer 409 and a first electron accelerating layer 412b having the same width as the first electrode 412a and formed on the surface of the first electrode 412a.

The green electron emitting source 413 includes a second electrode 413a formed on the upper surface of the rear dielectric layer 409 in other discharge cells adjacent to the discharge cells in which the red electron emitting source 412 is disposed and a second electron accelerating layer 413b having the same width as the second electrode 413a and formed on the surface of the second electrode 413a.

The blue electron emitting sources 414 and 415 include a third electrode 414a formed on the upper surface of the rear dielectric layer 409 in other discharge cells adjacent to the discharge cells in which the green electron emitting source 413 is disposed, a third electron accelerating layer 414b having the same width as the third electrode 414a and formed on the surface of the third electrode 414a, a fourth electrode 415a, and a fourth electron accelerating layer 415b having the same width as the fourth electrode 415a and formed on the surface of the fourth electrode 415a.

In this case, the third electrode 414a and the fourth electrode 415a are separated from each other to be adjacent to a pair or barrier ribs 410 adjacent in the blue discharge cells. In addition, the third electrode 414a and the fourth electrode 415a are disposed in a direction perpendicular to the X electrode 404 and the Y electrode 405.

The plurality of third and fourth electrodes 414a and 415a are separated from each other and disposed along edges of the discharge cells because the amount of electrons to be supplied to edges of the discharge cells is increased so that the area of the blue discharge cells having lower brightness than the red and green discharge cells can be increased and the amount of electrons to be supplied can be increased.

As such, even when the same power is applied to the red electron emitting source 412, the green electron emitting source 413, and the blue electron emitting source 414, respectively, the amount of electrons supplied to the blue discharge cells in which the blue electron emitting sources 414 and 415 are disposed is larger than the amount of electrons supplied to the red discharge cells in which the red electron emitting source 412 is disposed or the amount of electrons supplied to the green discharge cells in which the green electron emitting source 413 is disposed.

In this case, the first through fourth electron accelerating layers 412b, 413b, 414b, and 415b may be formed of a material in which atoms are accelerated and electron beams can be generated, for example, oxidized porous silicon (OPS) or OPS including oxidized porous amorphous silicon.

A discharge gas is injected in an internal space sealed by the front substrate 401 and the rear substrate 402 combined with each other. The discharge gas can be, for example, xenon (Xe) gas, neon (Ne) gas, helium (He) gas, argon (Ar) gas or or any mixture thereof.

In the PDP 400 having the above structure according to the present embodiments, due to an electric field formed between the Y electrode 405 and the address electrode 408 during an address discharge, electrons flow into the first through fourth electron accelerating layers 412b, 413b, 414b, and 415b from the first through fourth electrodes 412a, 413a, 414a, and 415a. The electrons pass through the first through fourth electron accelerating layers 412b, 413b, 414b, and 415b and are accelerated and then are emitted into the discharge cells. If the electrons flow into the discharge cells in this way, the address discharge can occur smoothly. Thus, an address driving voltage can be reduced and a sufficient address discharge can be performed.

In addition, even in the sustain discharge, due to the electric field formed between the X electrode 404 and the Y electrode 405, electrons pass through the first through fourth electron accelerating layers 412b, 413b, 414b, and 415b from the first through fourth electrodes 412a, 413a, 414a, and 415a and are accelerated and then are emitted into the discharge cells. Thus, a sustain discharge voltage to be applied during the sustain discharge is reduced so that a sustain discharge can be performed.

Furthermore, in order to improve discharge brightness in the blue discharge cells having lower discharge efficiency, the areas of the blue electron emitting sources 414 and 415 disposed in the blue discharge cells are larger than the area of the red electron emitting source 412 disposed in the red discharge cells and the area of the green electron emitting source 413 disposed in the green discharge cells. As such, a large amount of electrons is generated in the blue discharge cells, and a large amount of excitation species is formed in the discharge cells such that brightness is compensated for.

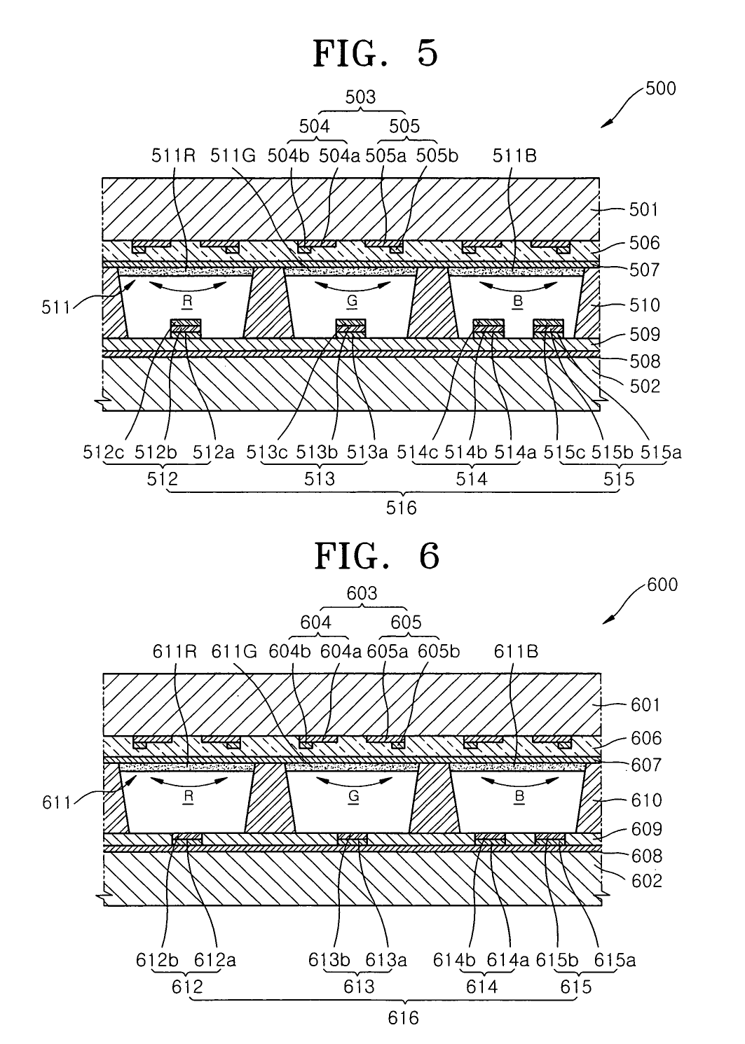

FIG. 5 illustrates a plasma display panel (PDP) 500 according to another embodiment. Referring to FIG. 5, the PDP 500 includes a front substrate 501 and a rear substrate 502 that opposes the front substrate 501.

A pair of sustain discharge electrodes 503 are disposed on an inner surface of the front substrate 501. The pair of sustain discharge electrodes 503 include an X electrode 504 and a Y electrode 505. The X electrode 504 includes a first discharge electrode line 504a and a first bus electrode line 504b disposed along one edge of the first discharge electrode line 504a. The Y electrode 505 includes a second discharge electrode line 505a and a second bus electrode line 505b disposed along one edge of the second discharge electrode line 505a. The pair of sustain discharge electrodes 503 are buried by a front dielectric layer 506. A protective layer 507 is formed on the surface of the front dielectric layer 506.

An address electrode 508 is disposed on an inner surface of the rear substrate 502 to cross the pair of sustain discharge electrodes 503. The address electrode 508 is buried by a rear dielectric layer 509.

Barrier ribs 510 are disposed between the front substrate 501 and the rear substrate 502. A light emitting layer 511 is coated on an inner surface of the protective layer 507 in each of discharge cells. The light emitting layer 511 includes a red emitting layer 511R, a green light emitting layer 511G, and a blue light emitting layer 511B.

In this case, an electron emitting source 515 is disposed in a discharge space defined by the barrier ribs 510. The electron emitting source 515 includes a red electron emitting source 512, a green electron emitting source 513, and blue electron emitting sources 514 and 515.

The red electron emitting source 512 includes a first electrode 512a formed on an upper surface of the rear dielectric layer 509, a first electron accelerating layer 512b formed on the surface of the first electrode 512a, and a second electrode 512c formed on an upper surface of the first electron accelerating layer 512b.

The green electron emitting source 513 includes a second electrode 513a formed on the upper surface of the rear dielectric layer 509 in other discharge cells adjacent to the discharge cells in which the red electron emitting source 512 is disposed, a second electron accelerating layer 513b formed on the surface of the second electrode 513a, and a fourth electrode 513c formed on an upper surface of the second electron accelerating layer 513b.

The blue electron emitting sources 514 and 515 are disposed not in the center of the discharge cells but on both edges of the discharge cells in which the pair of adjacent barrier ribs 510 are disposed. That is, a fifth electrode 514a, a third electron accelerating layer 514b formed on the surface of the fifth electrode 514a, and a sixth electrode 515c formed on an upper surface of the third electron accelerating layer 514b are disposed on one edge of the discharge cells. In addition, a seventh electrode 515a, a fourth electron accelerating layer 515b formed on the surface of the seventh electrode 515a, and an eighth electrode 515c formed on an upper surface of the fourth electron accelerating layer 515b are disposed on the other edge of the discharge cells.

As such, the first, third, fifth, and seventh electrodes 512a, 513a, 514a, and 515a are cathode electrodes, and the second, fourth, sixth, and eighth electrodes 512c, 513c, 514c, and 514c are grid electrodes. In addition, if a predetermined power is applied to the first, third, fifth, and seventh electrodes 512a, 513a, 514a, and 515a, respectively, and the second, fourth, sixth, and eighth electrodes 512c, 513c, 514c, and 515c, respectively, the first through fourth electron accelerating layers 512b, 513b, 514b, and 515b accelerate electrons flowing from the first, third, fifth, and seventh electrodes 512a, 513a, 514a, and 515a and can emit electron beams into the discharge cells via the second, fourth, sixth, and eighth electrodes 512c, 513c, 514c, and 515c.

In this case, the electron beams may be larger than an energy needed in exciting a gas and smaller than an energy needed in ionizing the gas. Thus, a predetermined voltage having an optimized electron energy in which electron beams can excite a discharge gas may be applied to the first, third, fifth, and seventh electrodes 512a, 513a, 514a, and 515a, respectively, and the second, fourth, sixth, and eighth electrodes 512c, 513c, 514c, and 515c, respectively.

In this way, since the areas of the blue electron emitting sources 514 and 515 disposed in the blue discharge cells are larger than the area of the red electron emitting source 512 disposed in the red discharge cells and the area of the green electron emitting source 513 disposed in the green discharge cells. As such, a large amount of electrons is generated in the blue discharge cells and brightness can be compensated for.

FIG. 6 illustrates a plasma display panel (PDP) 600 according to another embodiment. Referring to FIG. 6, the PDP 600 includes a front substrate 601 and a rear substrate 602 that opposes the front substrate 601.

A pair of sustain discharge electrodes 603 are disposed on an inner surface of the front substrate 601. The pair of sustain discharge electrodes 603 include an X electrode 604 and a Y electrode 605. The X electrode 604 includes a first discharge electrode line 604a and a first bus electrode line 604b disposed on an upper surface of the first discharge electrode line 604a. The Y electrode 605 includes a second discharge electrode line 605a and a second bus electrode line 605b disposed on an upper surface of the second discharge electrode line 605a. The pair of sustain discharge electrodes 603 are buried by a front dielectric layer 606. A protective layer 607 is formed on an inner surface of the front dielectric layer 606.

An address electrode 608 is disposed on an inner surface of the rear substrate 602 to cross the pair of sustain discharge electrodes 603. The address electrode 608 is buried by a rear dielectric layer 609.

Barrier ribs 610 are disposed between the front substrate 601 and the rear substrate 602. A light emitting layer 611 is applied to the discharge cells defined by the barrier ribs 610. According to the current embodiment, the red, green, and blue light emitting layers 611R, 611G, and 611R, respectively, are applied to adjacent discharge cells along an inner surface of the protective layer 607.

In this case, an electron emitting source 616 is disposed on an upper surface of the address electrode 608. The electron emitting source 616 includes a red electron emitting source 612, a green electron emitting source 613, and blue electron emitting sources 614 and 615.

The red electron emitting source 612 includes a first electron accelerating layer 612a that contacts the surface of the address electrode 608 and a first electrode 612b having the same width as the first electron accelerating layer 612a. The address electrode 608 is an electrode for supplying electrons, as mentioned in FIGS. 4 and 5.

The green electron emitting source 613 includes a second electron accelerating layer 613a formed on the surface of the address electrode 608 in other discharge cells adjacent to the discharge cells in which the red electron emitting source 612 is disposed and a second electrode 613b formed on the surface of the second electron accelerating layer 613a.

The blue electron emitting sources 614 and 615 are disposed in other discharge cells adjacent to the discharge cells in which the green electron emitting source 613 is disposed. The blue electron emitting sources 614 and 615 are disposed along both edges of the discharge cells to be adjacent to a pair of adjacent barrier ribs 610.

That is, a third electron accelerating layer 614a formed on the surface of the address electrode 608 and a third electrode 614b formed on the surface of the third electron accelerating layer 614a are formed on one edge of the discharge cells. In addition, a fourth electron accelerating layer 615a formed on the surface of the address electrode 608 and a fourth electrode 615b formed on the surface of the fourth electron accelerating layer 615a are formed on the other edge of the discharge cells.

In this case, the first through fourth electron accelerating layers 612a through 615a are oxidized porous silicon (OPS) layers. The OPS layer includes oxidized porous poly silicon (OPPS) or oxidized porous amorphous silicon (OPAS).

In addition, the first through fourth electron accelerating layers 612a through 615a contact the surface of the address electrode 608 but the present embodiments are not limited to this. That is, an electron accelerating layer may contact the side of the address electrode 608 and may be a structure in which the electron accelerating layer contacts the address electrode 608 and electrons flow into the electron accelerating layer. Thus, there is no limitation in the arrangement shape of the electron accelerating layer.

In particular, the areas of the blue electron emitting sources 614 and 615 are larger than the area of the red electron emitting source 612 and the area of the green electron emitting source 613. By making the areas of the blue electron emitting sources 614 and 615 larger than the areas of the red and green electron emitting sources 612 and 613, lowering of brightness is compensated for in the blue discharge cells due to a material characteristic of the blue light emitting layer 611 B.

As described above, the plasma display panel (PDP) according to the present embodiments has the following effects. [01491 Firstly, the electron emitting source is installed in the discharge cells such that an electron emission characteristic is improved and brightness and luminous efficiency of the PDP can be improved. Secondly, the driving voltage for firing a discharge can be reduced. Thirdly, the area of the electron emitting source or the number of electron emitting sources differs in each of the discharge cells such that a discharge characteristic in discharge cells having lower brightness can be improved. Fourthly, luminous efficiency can be improved.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a front substrate;
a rear substrate opposing the front substrate;
a plurality of discharge electrodes disposed inside the substrates;
a plurality of discharge cells;
a plurality of light emitting layers formed inside the discharge cells; and
an electron emitting source disposed inside each discharge cell so as to
supply electrons, wherein not all of the electron emitting sources are the same size.

2. The plasma display panel of claim 1, wherein the electron emitting source comprises:
a first electrode configured to be a source for emitting electrons; and
an electron accelerating layer formed on the first electrode.

3. The plasma display panel of claim 2, wherein the electron accelerating layer comprises one layer selected from the group consisting of an oxidized porous poly silicon (OPPS) layer and an oxidized porous amorphous silicon (OPAS) layer.

4. The plasma display panel of claim 2, further comprising a second electrode formed on the electron accelerating layer in such a manner that an electric field can be formed between the first electrode and the second electrode.

5. The plasma display panel of claim 2, further comprising a second electrode formed on the electron accelerating layer in such a manner that an electric field can be formed between the first electrode and the second electrode, wherein the discharge electrodes comprise a first electrode.

6. The plasma display panel of claim 1, wherein the size of the electron emitting source disposed in discharge cells having lower brightness is larger than the size of an electron emitting source disposed in discharge cells having higher brightness.

7. The plasma display panel of claim 2, wherein the discharge electrodes comprise:
a plurality of sustain discharge electrode pairs disposed in the same direction and performing a sustain discharge; and
an address electrode disposed in a direction that crosses the sustain discharge electrode pairs and performing an address discharge.

8. The plasma display panel of claim 7, wherein the address electrode is the first electrode, and a second electrode is further formed on the electron accelerating layer so that an electric field can be formed between the address electrode and the second electrode.

9. The plasma display panel of claim 1, wherein the electron emitting source comprises two electrodes and an electron accelerating layer.

10. A plasma display panel comprising:
a front substrate;
a rear substrate opposing the front substrate;
a plurality of discharge electrodes disposed inside the substrates;
a plurality of light emitting layers applied inside discharge cells; and
an electron emitting source disposed inside the discharge cells so as to
supply electrons, the number of electron emitting sources differing in each of the discharge cells.

11. The plasma display panel of claim 10, wherein the electron emitting source comprises:
a first electrode which becomes a source for emitting electrons; and
an electron accelerating layer formed on the first electrode.

12. The plasma display panel of claim 11, wherein the electron accelerating layer is one layer selected from the group consisting of an oxidized porous poly silicon (OPPS) layer and an oxidized porous amorphous silicon (OPAS) layer.

13. The plasma display panel of claim 11, wherein a second electrode is further formed on the electron accelerating layer so that an electric field can be formed between the first electrode and the second electrode.

14. The plasma display panel of claim 11, wherein the discharge electrodes are the first electrode, and a second electrode is further formed on the electron accelerating layer so that an electric field can be formed between the first electrode and the second electrode.

15. The plasma display panel of claim 11, wherein the light emitting layer is formed on an inner surface of other substrate corresponding to a substrate on which the electron emitting source is installed.

16. The plasma display panel of claim 11, wherein the number of electron emitting sources disposed in discharge cells having lower brightness is larger than the number of electron emitting sources disposed in discharge cells having higher brightness.

17. The plasma display panel of claim 16, wherein a plurality of electron emitting sources disposed in discharge cells having lower brightness, respectively, are disposed along both opposed edges of the discharge cells.

18. The plasma display panel of claim 11, wherein the discharge electrodes comprise:
a plurality of sustain discharge electrode pairs disposed in the same direction and performing a sustain discharge; and
an address electrode disposed in a direction that crosses the sustain discharge electrode pairs and performing an address discharge.

19. The plasma display panel of claim 18, wherein the address electrode is the first electrode and a second electrode is further formed on the electron accelerating layer so that an electric field can be formed between the first electrode and the second electrode.

20. The plasma display panel of claim 10, wherein the electron emitting source comprises two electrodes and an electron accelerating layer.
